(19) United States
(12) Patent Application Publication
(10) Pub. No.: US 2020/0361727 A1
(43) Pub. Date: Nov. 19, 2020

(54) BULK MATERIAL SHIPPING CONTAINER UNLOADER APPARATUS

(71) Applicant: SANDBOX LOGISTICS, LLC, Houston, TX (US)

(72) Inventors: C. John Allegretti, Barrington Hills, IL (US); Kevin Sylvester Corrigan, Forest Park, IL (US); Matthew Cook, Denver, CO (US)

(21) Appl. No.: 16/412,181

(22) Filed: May 14, 2019

(51) Int. Cl. B65G 67/24

(52) U.S. Cl. CPC B65G 67/24; B65G 2201/04

(57) ABSTRACT

A bulk material shipping container unloader apparatus having a plurality of unloaders and shared triple redundant power and control assembly.

### BACKGROUND

Various bulk material shipping containers are known. Such known material bulk shipping containers, sometimes referred to herein for brevity as known containers or as known bulk containers, are used to transport a wide range of products, parts, components, items, and materials such as, but not limited to, seeds, shavings, fasteners, and granular materials (such as sand). These are sometimes called loose materials or materials. New and improved bulk material shipping containers are continuously being developed. For example, U.S. Published Patent Application No. 2018/0002066, which is owned by the assignee of the present application and incorporated herein by reference, discloses relatively new bulk material shipping containers.

As these new bulk material shipping containers are developed, there is a continuing need to develop unloading devices that can be used for unloading loose materials from these new bulk material shipping containers. In various uses, certain of these new bulk material shipping containers need to be supported substantially above the ground to be unloaded. New and improved bulk material shipping container unloader apparatus are continuously being developed. For example, U.S. Published Patent Application No. 2018/002120, which is owned by the assignee of the present application and incorporated herein by reference, discloses relatively new bulk material shipping container unloader apparatus.

There is a continuing need for new and improved bulk material shipping container unloader apparatus.

### SUMMARY

Various embodiments of the present disclosure provide bulk material shipping container unloader apparatus that meets the above needs. In various embodiments, the apparatus includes multiple individual material shipping container unloaders that are sometimes referred to herein for brevity as the unloader(s). In various embodiments, the multiple bulk material shipping container unloaders of the apparatus of the present disclosure are adjacently positioned, connected, employed together, operate together, and are controlled and powered by integrated shared control and power systems. In various embodiments of the unloader apparatus of the present disclosure, the shared control and power systems include a triple redundant shared power and control assembly as further described below.

Additional features and advantages of the present invention are described in, and will be apparent from, the following Detailed Description of Exemplary Embodiments and the figures.

### DESCRIPTION OF THE DRAWINGS

FIG. 1 is a front view of the bulk material shipping container unloader apparatus of one example of the present disclosure and including three adjacently positioned bulk material shipping container unloaders of an example embodiment of the present disclosure supported by a rack of an example embodiment of the present disclosure, and including a shared power and control assembly of an example embodiment of the present disclosure and supported by the rack.

FIG. 2 is a rear view of the three bulk material shipping container unloaders, the rack, and the shared power and control assembly of FIG. 1.

FIG. 3 is a right side view of the three bulk material shipping container unloaders, the rack, and the shared power and control assembly of FIG. 1.

FIG. 4 is a left side view of the three bulk material shipping container unloaders, the rack, and the shared power and control assembly of FIG. 1.

FIG. 5 is an enlarged front perspective view of one of the three bulk material shipping container unloaders, part of the rack, and the shared power and control assembly of FIG. 1

FIG. 6 is an enlarged front perspective view of one of the three bulk material shipping container unloaders, part of the rack, and the shared power and control assembly of FIG. 1

### DETAILED DESCRIPTION OF EXEMPLARY EMBODIMENTS

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

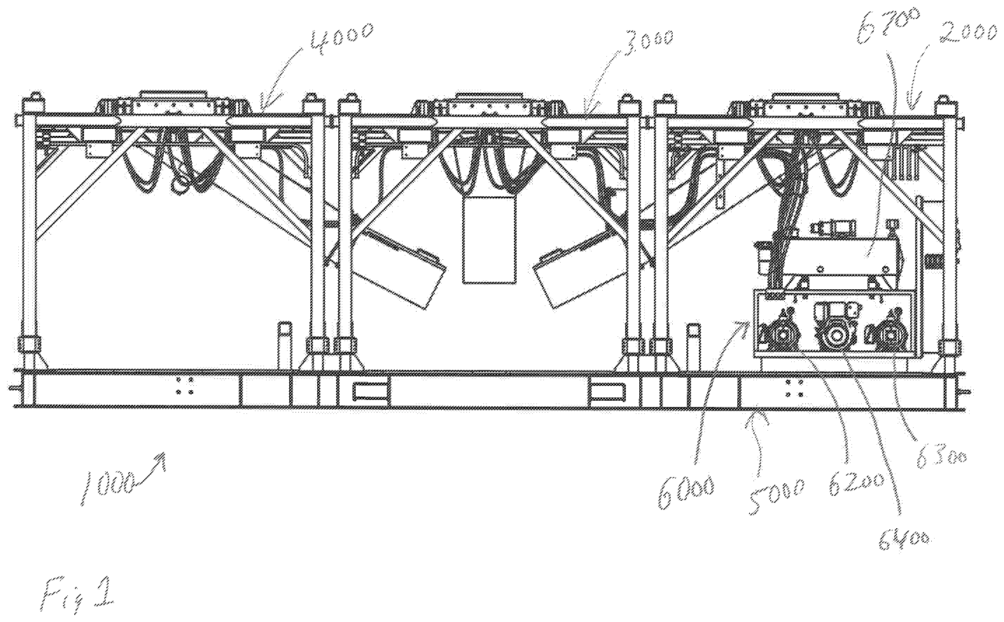

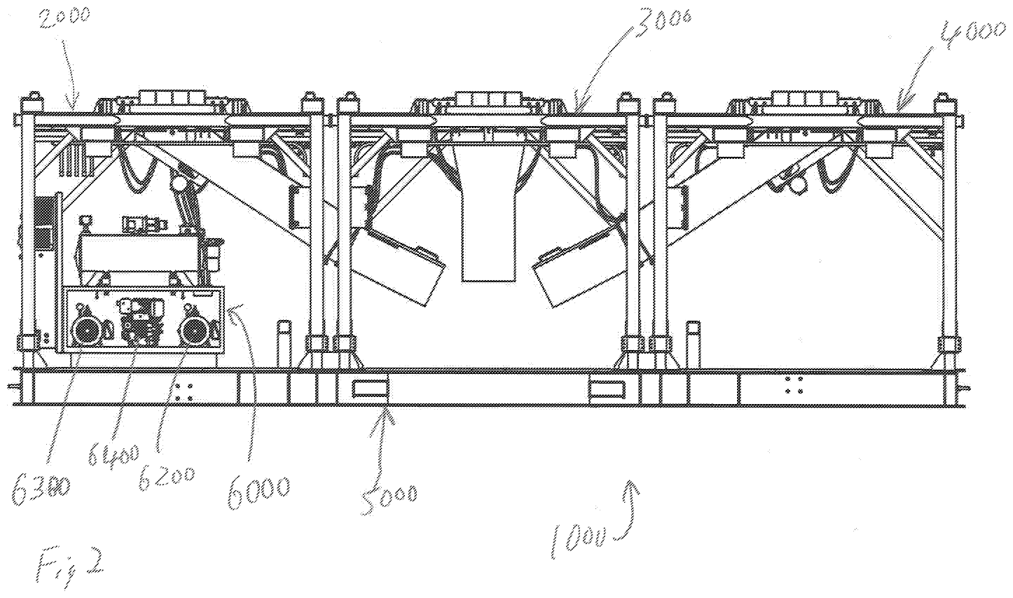

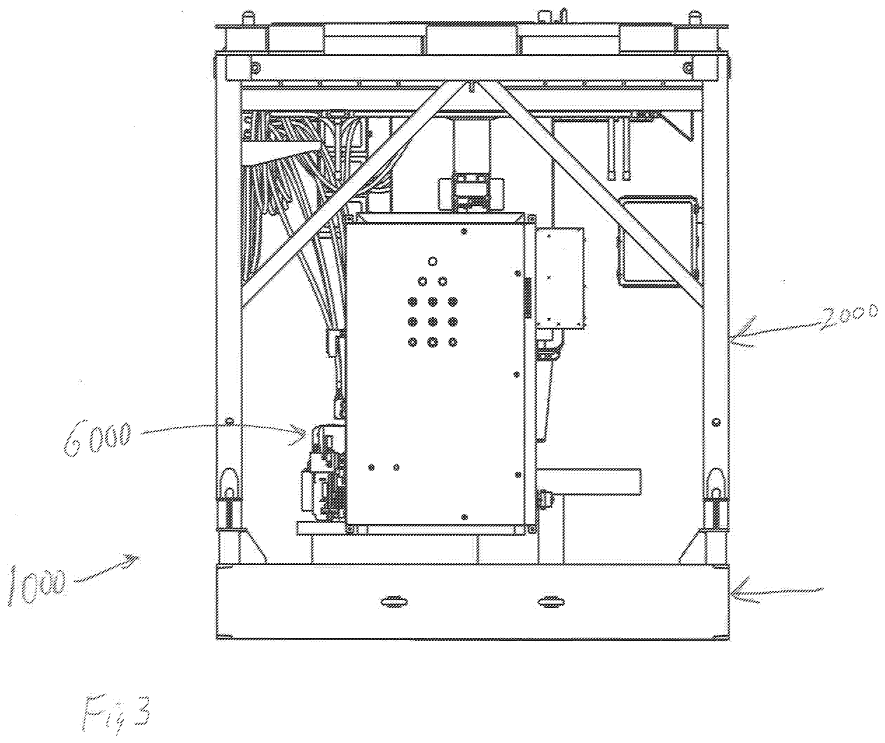

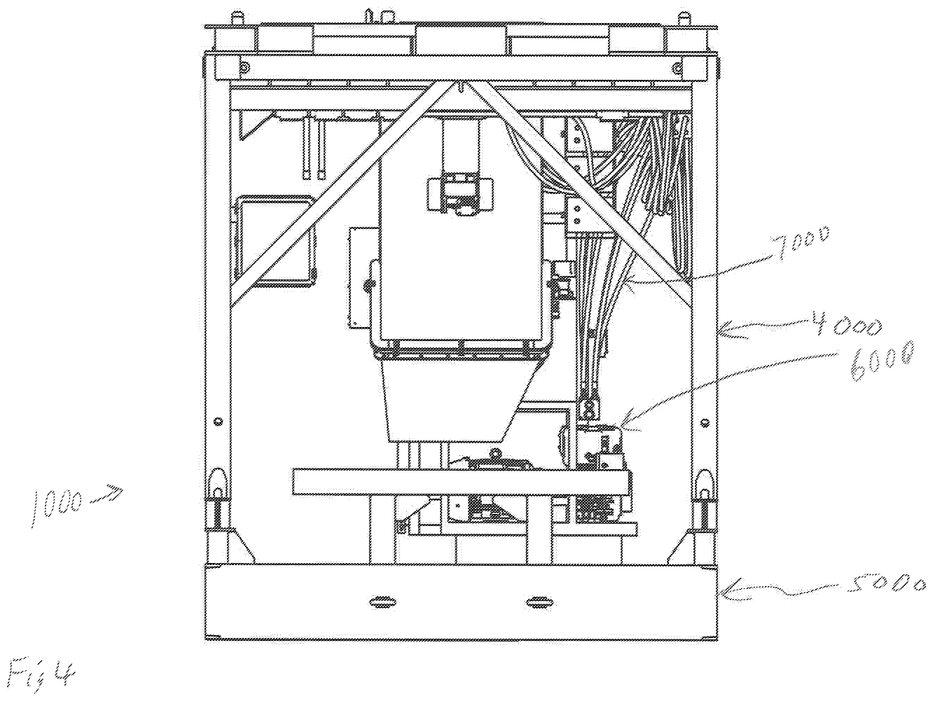

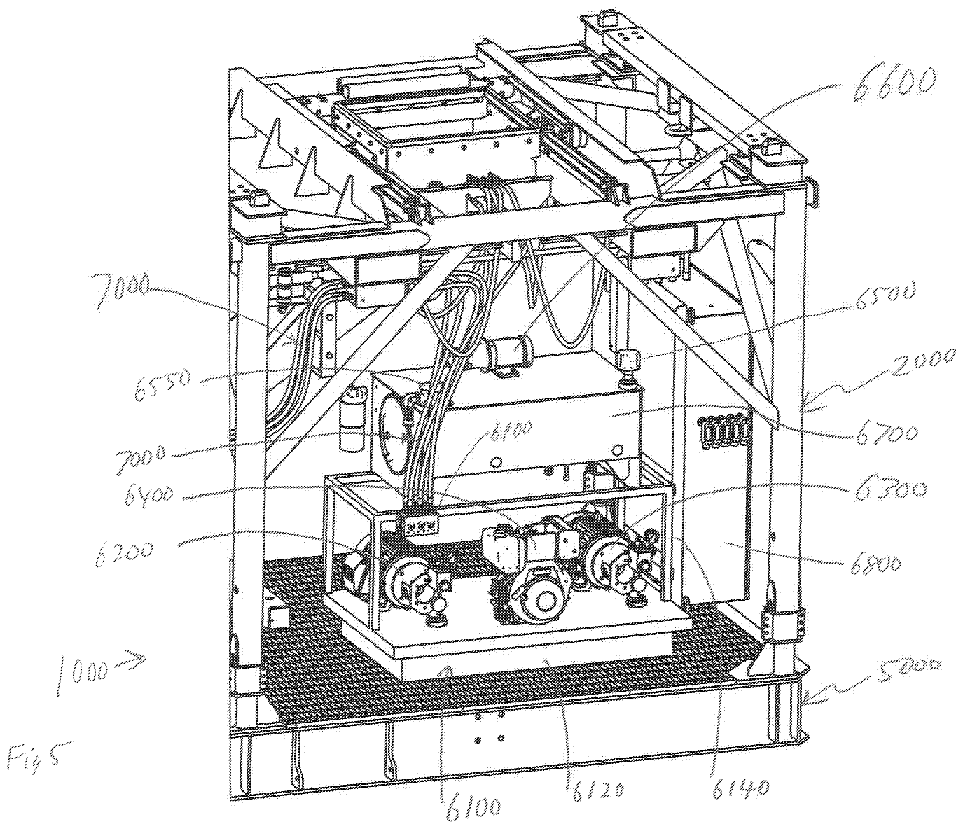

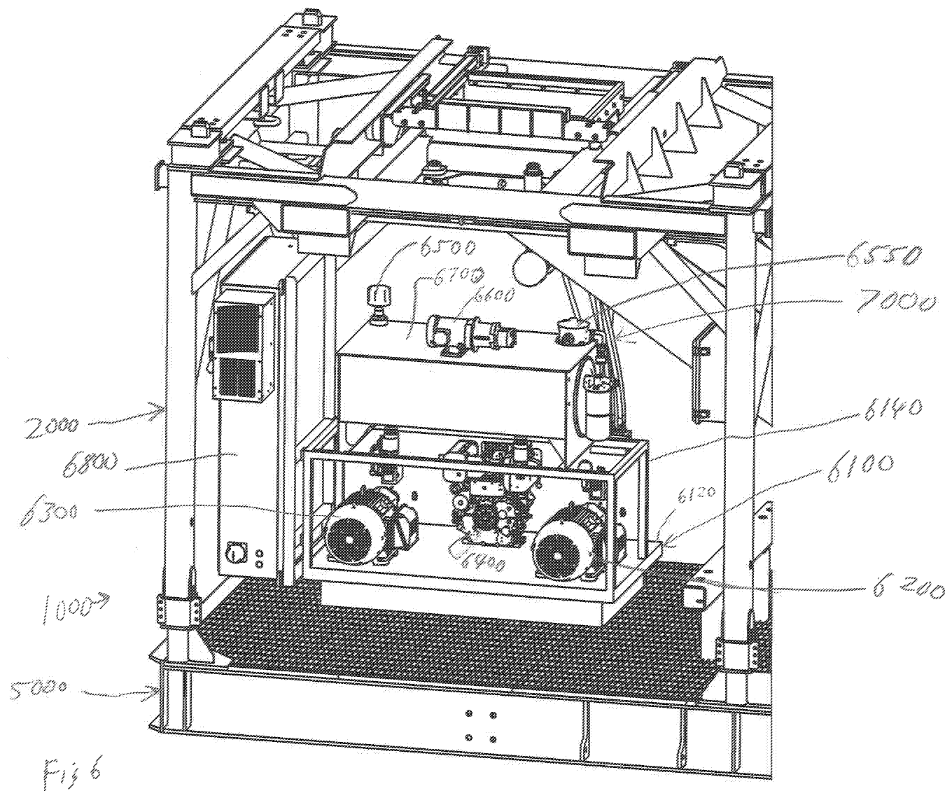

Referring specifically now to FIGS. 1 to 6, three co-operating example bulk material shipping container unloaders of the bulk material shipping container unloader apparatus 1000 of the present disclosure are illustrated adjacent to each other and respectively indicated by numerals 2000, 3000, and 4000. As mentioned above, for brevity, the bulk material shipping container unloaders 2000, 3000, and 4000 are often referred to herein as unloaders 2000, 3000, and 4000.

These unloaders 2000, 3000, and 4000 of the unloader apparatus 1000 each include various components of the bulk material container unloaders described in U.S. Patent Publication No. 2018/002120 which is incorporated herein by reference. It should be appreciated that various components of the unloaders 2000, 3000, and 4000 are not described herein or not described herein in any detail because such components are described in detail in that patent application.

As best shown in FIGS. 1 to 6, the example unloaders 2000, 3000, and 4000 of the unloader apparatus 1000 are configured to adjacently (or side by side) rest on and be supported by a rack 5000 of the unloader apparatus 1000. It should be appreciated that the rack 5000 can be employed with one or more unloaders of the present disclosure or other suitable unloaders. It should be appreciated that the rack may include certain components that are described in more detail in U.S. Published Patent Application 2018/002120.

The three example bulk material shipping container unloaders 2000, 3000, and 4000 of the unloader apparatus 1000 are configured to respectively support three of the same or identical bulk material shipping containers (not shown in FIGS. 1 to 6). It should be appreciated that the unloaders 2000, 3000, and 4000 are each configured to support a shipping container that includes a compartment having a bottom portion with a selectively openable and closeable material unloading assembly, and specifically where: (i) such material unloading assembly includes a gate or closure member with a downwardly extending handle or engagement member; and (ii) the gate is movable or slidable from a closed position to a plurality of different partially open positions, then to a fully open position, and then back to the closed position as described in U.S. Published Patent Application 2018/002120. The unloaders 2000, 3000, and 4000 of the unloader apparatus 1000 are configured to operate, under the control of a shared power and control assembly 6000 of the unloader apparatus, individually and together to open and close the respective gates of the respective material unloading assemblies of the containers respectively positioned on the unloaders 2000, 3000, and 4000 and direct loose materials (such as sand) stored in such containers to a common material receiver (not shown) such as a material blender (not shown) positioned at a retrieval location under the centrally positioned unloader 3000 as generally shown in U.S. Published Patent Application 2018/002120.

In this illustrated example embodiment, the shared power and control assembly 6000 includes: (1) a frame assembly 6100; (2) a first electrically powered hydraulic fluid pump 6200; (3) a second electrically powered hydraulic fluid pump 6300; (4) a diesel powered hydraulic fluid pump 6400; (5) a filter assembly 6500 and a breather assembly 6550; (6) a recirculation pump assembly 6600; (7) a hydraulic fluid reservoir 6700; (8) an automatic control assembly 6800; (9) a manual control assembly 6900; (10) a plurality of hydraulic fluid communication lines 7000 (not individually labeled); and (11) suitable values, connectors, etc. (not all shown or labeled) for connecting such components.

In this illustrated example embodiment, the frame assembly 6100 includes a suitable support 6120 that rests on, is supported by, and may be suitably attached to the rack 5000. The support 6120 is configured to support the first electrically powered hydraulic fluid pump 6200, the second electrically powered hydraulic fluid pump 6300, the diesel powered hydraulic fluid pump 6400, and various other components of the power and control assembly 6000. The frame assembly 6100 also includes a shelf assembly 6140 suitably connected to and extending upwardly from the support 6120. The shelf assembly is configured to support the filter assembly 6500, the breather assembly 6550, the recirculation pump assembly 6600, the hydraulic fluid reservoir 6700, the manual control assembly 6900, and one or more other components of the power and control assembly 6000. The frame assembly 6100 is made from steel in this example embodiment; however, it should be appreciated that the frame assembly can be made from other suitable materials in accordance with the present disclosure. It should also be appreciated that the frame assembly may be otherwise suitably configured in accordance with the present disclosure.

In this illustrated example embodiment, the first electrically powered hydraulic fluid pump 6200 includes a suitable first electric motor (not labeled), a suitable first hydraulic fluid pump (not labeled), and various related components (not labeled) for the connection and operation thereof which will be appreciated by one of ordinary skill in the art and thus not described herein. The first electrically powered hydraulic fluid pump 6200 is suitably securely mounted to the support 6100 of the frame assembly 6200. The first electrically powered hydraulic fluid pump 6200 is suitably fluidly connected by certain of the fluid communication lines to the hydraulic fluid reservoir 6700, the automatic control assembly 6800, and the manual control assembly 6900. The first electrically powered hydraulic fluid pump 6200 is suitably configured to selectively supply hydraulic fluid to each of the respective gate mover assemblies of the unloaders 2000, 3000, and 4000 under the selective control of the automatic control assembly 6800 and the manual control assembly 6900.

In this illustrated example embodiment, the second electrically powered hydraulic fluid pump 6300 also includes a suitable second electric motor (not labeled), a suitable second hydraulic fluid pump (not labeled), and various related components (not labeled) for the connection and operation thereof which will be appreciated by one of ordinary skill in the art and thus not described herein. The second electrically powered hydraulic fluid pump 6300 is suitably securely mounted to the support 6100 of the frame assembly 6200. The second electrically powered hydraulic fluid pump 6300 is suitably fluidly connected by certain of the fluid communication lines to the hydraulic fluid reservoir 6700, the automatic control assembly 6800, and the manual control assembly 6900. The second electrically powered hydraulic fluid pump 6300 is suitably configured to selectively supply hydraulic fluid to each of the respective gate mover assemblies of the unloaders 2000, 3000, and 4000 under the selective control of the automatic control assembly 6800 and the manual control assembly 6900.

In this illustrated example embodiment, the diesel powered hydraulic fluid pump 6400 includes a suitable diesel motor (not labeled), a suitable third hydraulic fluid pump (not labeled), and various related components (not labeled) for the connection and operation thereof which will be appreciated by one of ordinary skill in the art and thus not described herein. The diesel powered hydraulic fluid pump 6400 is suitably securely mounted to the support 6100 of the frame assembly 6200. The diesel powered hydraulic fluid pump 6400 is suitably fluidly connected by certain of the fluid communication lines to the hydraulic fluid reservoir 6700, the automatic control assembly 6800, and the manual control assembly 6900. The diesel powered hydraulic fluid pump 6400 is suitably configured to selectively supply hydraulic fluid to each of the respective gate mover assemblies of the unloaders 2000, 3000, and 4000 under the selective control of the automatic control assembly 6800 and the manual control assembly 6900. In various embodiments, the diesel powered hydraulic fluid pump has an automatic starting mechanism and/or a manual starting mechanism.

In this illustrated example embodiment, the filter assembly 6500 includes one or more suitable replaceable filters (not shown or labeled) configured to filter or clean the hydraulic fluid. The filter assembly 6500 is suitably connected to the fluid reservoir 6700.

In this illustrated example embodiment, the breather assembly 6550 is configured to control the intake and output of air for the fluid reservoir 6700. In various embodiments, the breather assembly enables air to enter and exit the fluid reservoir and the fluid level falls and rises, and as the cylinders are closed and opened. The breather assembly 6550 is suitably connected to the fluid reservoir 6700.

In this illustrated example embodiment, the recirculation pump assembly 6600 includes one or more recirculation pumps (not shown or individually labeled). The recirculation pump assembly 6600 is suitably connected to the fluid reservoir 6700.

In this illustrated example embodiment, the hydraulic fluid reservoir 6700 includes one or more tanks (not shown or labeled) configured to hold hydraulic fluid and multiple fluid connection line and valves (not shown or labeled) suitably connected to the tank(s).

In this illustrated example embodiment, the automatic control assembly 6800 includes: (1) one or more automatic controls that control the power to and operation of the first and second electrically powered hydraulic fluid pumps 6200 and 6300; (2) one or more automatic controls that control the operation of the diesel powered hydraulic fluid pump 6400; and (3) a plurality of independently controlled openable and closable control valves fluidly connected to the respective first and second electrically powered hydraulic fluid pumps 6200 and 6300, as well as the diesel powered hydraulic pump 6400. The automatic control assembly 6800 is configured to independently selectively control the operation of these hydraulic pumps and the opening and closing of each of the respective gate mover assemblies of the unloaders 2000, 3000, and 4000.

In this illustrated example embodiment, the manual control assembly 6900 includes: (1) a first manually operable valve (not labeled) fluidly connected to the first gate mover assembly of the unloader 2000 to manually control fluid flow to that gate mover assembly; (2) a second manually operable valve (not labeled) fluidly connected to the second gate mover assembly of the unloader 3000 to manually control fluid flow to that gate mover assembly; and (3) a third manually operable valve (not labeled) fluidly connected to the gate mover assembly of the unloader 4000 to manually control fluid flow to that gate mover assembly. These valves are manually operable in case automatic or remote control of the hydraulic system is lost. In alternative embodiments, the manual control assembly can include: (1) a manually operable valve (not shown or labeled) fluidly connected to the first electrically powered hydraulic fluid pump 6200; (2) a manually operable valve (not shown or labeled) fluidly connected to the first electrically powered hydraulic fluid pump 6300; and (3) a manually operable valve (not shown or labeled) fluidly connected to the diesel powered hydraulic fluid pump 6400, all for controlling fluid flow from such pumps.

It should be appreciated that the plurality of hydraulic fluid communication lines 7000, and the plurality of suitable values, connectors, etc. are suitably connected to facilitate operation of the first electrically powered hydraulic fluid pump 6200, the second electrically powered hydraulic fluid pump 6300, the diesel powered hydraulic fluid pump 6400, the filter assembly 6500, the breather assembly 6550, the recirculation pump assembly 6600, the hydraulic fluid reservoir 6700, the automatic control assembly 6800, and the manual control assembly 6900.

In this illustrated example embodiment, the power and control assembly 6000 including the first electrically powered hydraulic fluid pump 6200, the second electrically powered hydraulic fluid pump 6300, the diesel powered hydraulic fluid pump 6400, the filter assembly 6500, the breather assembly 6550, the recirculation pump assembly 6600, the hydraulic fluid reservoir 6700, the automatic control assembly 6800, the manual control assembly 6900, the plurality of hydraulic fluid communication lines 7000, and the values, connectors, etc. are arranged in a double redundant configuration such that: (1) the first electrically powered hydraulic fluid pump 6200 can be selectively employed to provide hydraulic fluid to the first gate mover assembly of the unloader 2000, the second gate mover assembly of the unloader 3000, and the third gate mover assembly of the unloader 4000; (2) the second electrically powered hydraulic fluid pump 6300 can be selectively employed to provide hydraulic fluid to the first gate mover assembly of the unloader 2000, the second gate mover assembly of the unloader 3000, and the third gate mover assembly of the unloader 4000; and (3) the diesel powered hydraulic fluid pump 6400 can be selectively employed to provide hydraulic fluid to the first gate mover assembly of the unloader 2000, the second gate mover assembly of the unloader 3000, and the third gate mover assembly of the unloader 4000. In this illustrated example embodiment, the power and control assembly 6000 can be configured such that: (1) if the first electrically powered hydraulic fluid pump 6200 fails, the second electrically powered hydraulic fluid pump 6300 can be employed; and (2) if the second electrically powered hydraulic fluid pump 6200 also fails, the diesel powered hydraulic fluid pump 6400 can be employed. Alternatively, in this illustrated example embodiment, the power and control assembly 6000 can be configured such that: (1) if the second electrically powered hydraulic fluid pump 6300 fails, the first electrically powered hydraulic fluid pump 6200 can be employed; and (2) if the first electrically powered hydraulic fluid pump 6200 also fails, the diesel powered hydraulic fluid pump 6400 can be employed. It should be appreciated from the above this this double redundant system is thus unlikely to suffer a complete failure such that the gate mover assemblies of the unloaders cannot be operated.

It should be appreciated that in various embodiments, the gate mover assembly of each of the unloaders 2000, 3000, and 4000 includes the first and second hydraulic pistons.

It should be appreciated that power and control assembly 6000 can include one or more indicators such as lights (not shown) that indicate the positions of each of the gate mover assemblies and thus the positions of the gates of the containers positioned on such unloaders.

It should be appreciated that the first electrically powered hydraulic fluid pump 6200, the second electrically powered hydraulic fluid pump 6300, and the diesel powered hydraulic fluid pump 6400 can be configured for automatic testing on a regular basis such as weekly or monthly.

Thus, in various embodiments, the present disclosure provides a bulk material shipping container unloader apparatus including: a rack; a first bulk material shipping container unloader supported by the rack; a second bulk material shipping container unloader supported by the rack and positioned on a first side of the first bulk material shipping container unloader; a third bulk material shipping container unloader supported by the rack and positioned on a second side of the first bulk material shipping container unloader; and a shared power and control assembly supported by the rack. In various such embodiments, the shared power and control assembly includes: a frame assembly supported by the rack; a first electrically powered hydraulic fluid pump; a second electrically powered hydraulic fluid pump; a diesel powered hydraulic fluid pump; a filter assembly; a breather assembly; a recirculation pump assembly; a hydraulic fluid reservoir; an automatic control assembly; a manual control assembly; and a plurality of hydraulic fluid communication lines.

In various such embodiments, the first electrically powered hydraulic fluid pump includes a first electric motor and a first hydraulic fluid pump fluidly connected by certain of the fluid communication lines to the hydraulic fluid reservoir, the automatic control assembly, and the manual control assembly.

In various such embodiments, the first electrically powered hydraulic fluid pump is configured to supply hydraulic fluid to each of a plurality of gate mover assemblies of the unloaders under selective control of the automatic control assembly and the manual control assembly.

In various such embodiments, the second electrically powered hydraulic fluid pump includes a second electric motor and a second hydraulic fluid pump fluidly connected by certain of the fluid communication lines to the hydraulic fluid reservoir, the automatic control assembly, and the manual control assembly.

In various such embodiments, the second electrically powered hydraulic fluid pump is configured to supply hydraulic fluid to each of the plurality of gate mover assemblies of the unloaders under selective control of the automatic control assembly and the manual control assembly.

In various such embodiments, the diesel powered hydraulic fluid pump includes a diesel motor and a third hydraulic fluid pump fluidly connected by certain of the fluid communication lines to the hydraulic fluid reservoir, the automatic control assembly, and the manual control assembly.

In various such embodiments, the diesel powered hydraulic fluid pump is configured to supply hydraulic fluid to each of the plurality of gate mover assemblies of the unloaders under selective control of the automatic control assembly and the manual control assembly.

In various such embodiments, the diesel powered hydraulic fluid pump has at least one of an automatic starting mechanism and a manual starting mechanism.

In various such embodiments, the automatic control assembly includes: (1) one or more automatic controls that control the power to and operation of the first and second electrically powered hydraulic fluid pumps; (2) one or more automatic controls that control the operation of the diesel powered hydraulic fluid pump; and (3) a plurality of independently controlled openable and closable control valves fluidly connected to the respective first and second electrically powered hydraulic fluid pumps and the diesel powered hydraulic pump.

In various such embodiments, the automatic control assembly is configured to independently control operation of the first, second, and third hydraulic pumps and the opening and closing of each of the respective gate mover assemblies of the unloaders.

In various such embodiments, the manual control assembly includes: (1) a first manually operable valve fluidly connected to a first one of the gate mover assemblies of a first one of the unloaders to manually control fluid flow to that gate mover assembly; (2) a second manually operable valve fluidly connected to a second one of the gate mover assemblies of a second one of the unloaders to manually control fluid flow to that gate mover assembly; and (3) a third manually operable valve fluidly connected to a third one of the gate mover assemblies of a third one of the unloaders to manually control fluid flow to that gate mover assembly.

In various such embodiments, the shared power and control assembly is configured in a double redundant configuration such that: (1) the first electrically powered hydraulic fluid pump is employable to provide hydraulic fluid to the first gate mover assembly of the first unloader, the second gate mover assembly of the second unloader, and the third gate mover assembly of the third unloader; (2) the second electrically powered hydraulic fluid pump is employable to provide hydraulic fluid to the first gate mover assembly of the first unloader, the second gate mover assembly of the second unloader, and the third gate mover assembly of the third unloader; and (3) the diesel powered hydraulic fluid pump is employable to provide hydraulic fluid to the first gate mover assembly of the first unloader the second gate mover assembly of the second unloader, and the third gate mover assembly of the third unloader.

In various such embodiments, the shared power and control assembly is configured such that: (1) if the first electrically powered hydraulic fluid pump fails, the second electrically powered hydraulic fluid pump can be employed; and (2) if the second electrically powered hydraulic fluid pump also fails, the diesel powered hydraulic fluid pump can be employed.

In various such embodiments, the shared power and control assembly is configured such that: (1) if the second electrically powered hydraulic fluid pump fails, the first electrically powered hydraulic fluid pump can be employed; and (2) if the first electrically powered hydraulic fluid pump also fails, the diesel powered hydraulic fluid pump can be employed.

It should be understood that modifications and variations may be effected without departing from the scope of the novel concepts of the present disclosure, and it should be understood that this application is to be limited only by the scope of the appended claims.

1. A bulk material shipping container unloader apparatus comprising:
a rack;
a first bulk material shipping container unloader supported by the rack;
a second bulk material shipping container unloader supported by the rack and positioned on a first side of the first bulk material shipping container unloader;
a third bulk material shipping container unloader supported by the rack and positioned on a second side of the first bulk material shipping container unloader; and
a shared power and control assembly supported by the rack and including:
a frame assembly supported by the rack;
a first electrically powered hydraulic fluid pump;
a second electrically powered hydraulic fluid pump;
a diesel powered hydraulic fluid pump;
a filter assembly;
a breather assembly;
a recirculation pump assembly;
a hydraulic fluid reservoir;
an automatic control assembly;
a manual control assembly; and
a plurality of hydraulic fluid communication lines.

2. The bulk material shipping container unloader assembly of claim 1, wherein the first electrically powered hydraulic fluid pump includes a first electric motor and a first hydraulic fluid pump fluidly connected by certain of the fluid communication lines to the hydraulic fluid reservoir, the automatic control assembly, and the manual control assembly.

3. The bulk material shipping container unloader assembly of claim 2, wherein the first electrically powered hydraulic fluid pump is configured to supply hydraulic fluid to each of a plurality of gate mover assemblies of the unloaders under selective control of the automatic control assembly and the manual control assembly.

4. The bulk material shipping container unloader assembly of claim 3, wherein the second electrically powered hydraulic fluid pump includes a second electric motor and a second hydraulic fluid pump fluidly connected by certain of the fluid communication lines to the hydraulic fluid reservoir, the automatic control assembly, and the manual control assembly.

5. The bulk material shipping container unloader assembly of claim 4, wherein the second electrically powered hydraulic fluid pump is configured to supply hydraulic fluid to each of the plurality of gate mover assemblies of the unloaders under selective control of the automatic control assembly and the manual control assembly.

6. The bulk material shipping container unloader assembly of claim 5, wherein the diesel powered hydraulic fluid pump includes a diesel motor and a third hydraulic fluid pump fluidly connected by certain of the fluid communication lines to the hydraulic fluid reservoir, the automatic control assembly, and the manual control assembly.

7. The bulk material shipping container unloader assembly of claim 6, wherein the diesel powered hydraulic fluid pump is configured to supply hydraulic fluid to each of the plurality of gate mover assemblies of the unloaders under selective control of the automatic control assembly and the manual control assembly.

8. The bulk material shipping container unloader assembly of claim 7, wherein the diesel powered hydraulic fluid pump has at least one of an automatic starting mechanism and a manual starting mechanism.

9. The bulk material shipping container unloader assembly of claim 8, wherein the automatic control assembly includes: (1) one or more automatic controls that control the power to and operation of the first and second electrically powered hydraulic fluid pumps; (2) one or more automatic controls that control the operation of the diesel powered hydraulic fluid pump; and (3) a plurality of independently controlled openable and closable control valves fluidly connected to the respective first and second electrically powered hydraulic fluid pumps and the diesel powered hydraulic pump.

10. The bulk material shipping container unloader assembly of claim 9, wherein the automatic control assembly is configured to independently control operation of the first, second, and third hydraulic pumps and the opening and closing of each of the respective gate mover assemblies of the unloaders.

11. The bulk material shipping container unloader assembly of claim 10, wherein the manual control assembly includes: (1) a first manually operable valve fluidly connected to a first one of the gate mover assemblies of a first one of the unloaders to manually control fluid flow to that gate mover assembly; (2) a second manually operable valve fluidly connected to a second one of the gate mover assemblies of a second one of the unloaders to manually control fluid flow to that gate mover assembly; and (3) a third manually operable valve fluidly connected to a third one of the gate mover assemblies of a third one of the unloaders to manually control fluid flow to that gate mover assembly.

12. The bulk material shipping container unloader assembly of claim 11, wherein the shared power and control assembly is configured in a double redundant configuration such that: (1) the first electrically powered hydraulic fluid pump is employable to provide hydraulic fluid to the first gate mover assembly of the first unloader, the second gate mover assembly of the second unloader, and the third gate mover assembly of the third unloader; (2) the second electrically powered hydraulic fluid pump is employable to provide hydraulic fluid to the first gate mover assembly of the first unloader, the second gate mover assembly of the second unloader, and the third gate mover assembly of the third unloader; and (3) the diesel powered hydraulic fluid pump is employable to provide hydraulic fluid to the first gate mover assembly of the first unloader the second gate mover assembly of the second unloader, and the third gate mover assembly of the third unloader.

13. The bulk material shipping container unloader assembly of claim 12, wherein the shared power and control assembly is configured such that: (1) if the first electrically powered hydraulic fluid pump fails, the second electrically powered hydraulic fluid pump can be employed; and (2) if the second electrically powered hydraulic fluid pump also fails, the diesel powered hydraulic fluid pump can be employed.

14. The bulk material shipping container unloader assembly of claim 12, wherein the shared power and control assembly is configured such that: (1) if the second electrically powered hydraulic fluid pump fails, the first electrically powered hydraulic fluid pump can be employed; and (2) if the first electrically powered hydraulic fluid pump also fails, the diesel powered hydraulic fluid pump can be employed.
